(19) United States
(12) Patent Application Publication
(10) Pub. No.: US 2004/0039807 A1
(43) Pub. Date: Feb. 26, 2004

(54) Methods and arrangements in a telecommunication network

(76) Inventors: Angel Boveda De Miguel, Madrid (ES); Manuel Lorenzo Hernandez, Madrid (ES); Jens Jonsson, Linkoping (SE); Anders Eriksson, Linkoping (SE); Ingvar Berg, Linkoping (SE); Lars Jensen, Stockholm (SE)

Correspondence Address: JENKENS & GILCHRIST, PC, 1445 ROSS AVENUE, SUITE 3200, DALLAS, TX, 75202, US

(21) Appl. No.: 10/387,633

(22) Filed: Mar. 13, 2003

(30) Foreign Application Priority Data
Apr. 25, 2002 (SE) 0201287-0

(51) Int. Cl. G06F 15/173

(52) U.S. Cl. 709/223

(57) ABSTRACT

The present invention relates to an arrangement and method for providing integration of different data relating to different services in a communication network with a plurality of service providers and service enablers. The system according to the invention provides a common subscriber/user database and subscriber/user data records with user and subscriber information. The subscriber/user data records comprise: at least one identification field identifying a subscriber and a user; and at least one service field specifying at least one selected service from the plurality of services provided in the service network, wherein the at least one selected service is selected by the user or subscriber. At least on of said at least one service field is provides links to affiliate data relating to the subscriber/user and which is stored outside of the common subscriber/user database.

### FIELD OF THE INVENTION

The present invention relates generally to the field of data distribution in communication networks and particularly to integration of different data relating to different services in a communication network with a plurality of service providers and service enablers.

### BACKGROUND OF THE INVENTION

Traditionally communication networks such as mobile telephony networks (PLMN), fixed circuit-switched networks (PSTN) and data communication networks have been separate systems. The telecommunication networks have been characterized as vertically integrated, meaning that applications and services are closely tied to the technique of transport. The mobile system GSM for example, provides a set of services and applications, those appearance, advantages and limitations, at least to a large extent, is given by the communication technique. A fixed telephone network (PSTN) has provided a different set of services and applications, closely linked to the communication technique used in the system, and the services often differ in usage and appearance from a similar service in a PLMN.

Services that appears similar to the end-user, may, due to the same close ties to the technique, be implemented very differently in the different networks.

The close link between the services and the communication technique has in addition been an important reason for the fact that the network operator has also been the dominating provider of services to the end-user. To provide a service, knowledge of, and access to, the complete network, has been crucial. A vertically integrated network is depicted in FIG. 1.

There is an increasing demand for a larger variation of services, complex services and to allow competition among service provider. At the same time has the tele- and data communication networks evolved. The new generations of communication systems integrates different communication technologies such as cellular telephony and IP-based data communication. The new systems are often pictured as horizontally layered, with e.g. an access layer, a core layer and a service layer. In FIG. 2 a layered communication system is depicted. In this scenario existing and new players for example operators, service providers, service enablers, content providers and application (Internet) service providers interact to offer the end-user a large variety of services. The service are offered and managed in the service layer, which has the form of a network, the service network 200. The service network 200 interacts with the core network 210, which typically has a IP architecture and provides transport and switching functionality. From the core network it is possible to communicate with a plurality of access networks. The access networks may be of various kinds, including cellular systems 220 with different capacity and characteristics such as GSM or UMTS, fixed telephony (PSTN) 230, IP based data communication 240, and cable TV 250. The service network 200 preferably has an open architecture, for example Open Service Architecture, OSA and an open interface, for example OSA application program interface, API, as to enable the multitude of players to interact for providing services to the end-users. A comparison between vertically integrated networks and layered networks can be found in Ericsson Review No. 2, 2001.

The offered services may preferably by tailored after the end-user's personal preference, the access method (mobile system, fixed system etc), characteristics of the accessing terminal (e.g. the capacity of a mobile terminal), subscription type etc. Although e.g. the access method will affect the execution of the service in the service network, many parts of the execution of a service will be similar or identical regardless of e.g. the access method. Hence, a service provider may use the same “building blocks” to construct different services adapted for different end-users. A building block may e.g. be a directory service, a message service or a positioning tool. The openness of the service networks as well as the possibility to use building blocks for more than one particular service are perceived as key factors in attracting both players like operators, service providers and service enablers and end-users to develop and use, respectively, new services.

The offered service will range from basic telephony services such as establishing a call between two mobile subscribers, to complex services involving different access networks, one or more Internet applications and security services. Complex services may include service using positioning, messaging and e-commerce. A positioning based service could e.g. be finding a hotel near the position of the end-user. Such a service could involve using the positioning tools of the mobile system via the mobile positioning centre, one or more Internet applications for finding and categorizing hotels in a certain area, applications that transforms the information to a format suitable for presentation on the terminal of the end-user, e.g. WAP, and e-commerce applications facilitating secure booking and payment of a room.

Another example of complex services relates to what is known as fleet management. Information on position of each individual user in a selected group of users is presented to one, or all, of the users in the group. The position of each user is provided by the positioning system. A user may this way get updated information on the positions of all others in the group. This type of services may be useful for example in managing a fleet of delivery vehicles. To offer and to execute such services a large number of interface between different service systems are required, and as different service systems may be provided by different service enablers, the need for service network and a service network that has an open architecture and standardized interfaces should be obvious.

The multitude of services provided in a service network by a multitude of service providers, enablers etc., the end-users spread in different access networks and with the demand of personalized services and different forms of payment, will increase the demand of correct end-user data and immediate access to that data is crucial. In the networks of today data related to the end-users are scattered throughout the network, and in many cases redundant end-user data is stored and used. The scattered storing of the data and the redundancy makes it difficult to retrieve and update the end-user information. It will, in the existing networks with their scattered end-user data, be very difficult to implement and to ensure a stable functionality of complex services. One drawback with the scattered end-user data may be illustrated with the example of a end-user ending its subscription to one complex service, which for example relies on a positioning service. All data relating to that subscriber is then removed from the service system that provides the positioning service. The end user may still want to use other complex services that uses the positioning, but since the end-user related data has been removed from the service system that provides the positioning service, these other complex service will lack crucial end-user related data. The complex services may in some case not be possible to perform, and in other cases, if the end-user data still can be retrieved from somewhere in the network, the execution of the complex service will be delayed and/or result in increased traffic load.

Furthermore, a user may be identified by different ID's, names or alias depending on the service. For example, a users phone number may be used by traditional telephony services, an email address by email-communication based services and an user alias by calendar based services. A complex service may need to access user data with different means of identification and if the user data is scattered all complex service has to store and update all user identities, The problems with existing handling of end-user data may be summarized as follows:

a) The end-user data relating to a service can not be immediately accessed, and to access the complete end-user data might be very difficult and time consuming,

b) It is not easy to gain information on how one service system relates to another service system, so that if, e.g., end-user data is changed, there is no knowledge of how other service systems are affected.

c) The spreading of the end-user data and the lack of knowledge of the relations between different service system considerably weakens the data consistency and increases the traffic load in the systems.

### SUMMARY OF THE INVENTION

The objective problem is, in a service network for providing complex service and/or a multitude of services, to provide a method, system and storage entities adapted for storing and accessing end-user and subscriber data, such that immediate access of the data is ensured and that the consistency of the data is maintained.

The problem is solved by the system as defined in claim 1, the data record according to claim 15, the method as defined in claim 35, by the use of the data model defined in claim 25REF and the computer program product as defined in claims 40 and 41.

The system according to one embodiment of the invention provides a common subscriber/user database, and subscriber/user data records with user and subscriber information. The subscriber/user data records comprise: at least one identification field identifying a subscriber and a user; and at least one service field specifying at least one selected service from the plurality of services provided in the service network, wherein the at least one selected service is selected by the user or subscriber. At least on of said at least one service field is adapted for providing links to affiliate data relating to the subscriber/user and which is stored outside of the common subscriber/user database. Thus, the common subscriber/user database and the subscriber/user records facilitate a single access point for accessing user and/or subscriber data in the service network.

The user/subscriber data is structured according to a user data model according to the invention. The user data model is adapted for facilitating storage of user and subscriber data in a common subscriber/user database, and the common subscriber/user database holds subscriber/user information relevant for a plurality of services. The model comprises: at least one identification object identifying a subscriber and a user; and at least one service object specifying at least one selected service from said plurality of services provided in the service network, wherein the at least one selected service is selected by the user or subscriber. At least on of said at least one service object provides links to affiliate data relating to the subscriber/user and which is stored outside of said common subscriber/user database. The common subscriber/user database and the data model facilitate a single access point for accessing user and/or subscriber data in the service network.

According to a further embodiment of the invention the subscriber/user data records comprise at least the two service fields: a service subscription field specifying a first group of services available to the subscriber, wherein the services in the first group of services is selected from said plurality of services provided in the service network; and at least one service activation field, each service activation field specifying a by the user activated service selected from the first group of services. The service subscription field and/or service activation fields are adapted for providing links to affiliate data relating to the subscriber/user and which affiliate data is stored outside of said common subscriber/user database.

The data record adapted for storing and maintaining user and subscriber data in a service network, according to the invention comprises: at least one identification field identifying a subscriber and a user; and at least one service field specifying at least one selected service from the plurality of services provided in the service network, wherein the at least one selected service is selected by the user or subscriber. At least on of said at least one service field is adapted for providing links to affiliate data relating to the subscriber/user and which is stored outside of the common subscriber/user database.

Thanks to the invention the common subscriber/user database and the user data records whereby provide a single access point for accessing user and subscriber data in the service network. Hence, a rapid access to user data is ensured and since the user data is access, and possibly added, updated or removed only through the single access point, data consistency may be achieved.

The method, according to one embodiment of the invention comprises the steps of:

accessing the single access point in the service network, provided by the system and data record described above;

requesting to read and/or write data from the single access point,

retrieving or transferring data from or to the user data record via the single access point.

One advantage afforded by the method according to the invention is that preferably all requests for user/subscriber data is directed to one place, the single access point, in the service network.

Another advantage afforded by the invention is that links to affiliate data and information required to access the affiliate data is provided by the system according to the invention, using the method according to the invention for retrieving said data.

Definitions

Service Network (SN)—corresponds to the service layer in the horizontally layered view of a communication system. Nodes, and a plurality of service systems, necessary to provide end-user services are considered as parts of the service network. Exactly which nodes which are considered to belong to the service network will depend on the implementation. Certain nodes may also belong to more than one layer/network.

Service system—System for providing a service, or part of a service. The service system typically belongs to the service network. A service system may use (communicate with) other service systems to provide a specific service to a end-user. A service system may provide one or more different services, or a group of services.

Complex-service—a service that need to engage two or more service systems to provide a specific service to the end-user.

### BRIEF DESCRIPTION OF THE FIGURES

The features and advantages of the present invention outlined above are described more fully below in the detailed description in conjunction with the drawings where like reference numerals refer to like elements throughout, in which:

FIG. 1 is a schematic drawing of a traditional, vertical integrated network;

FIG. 2 is a schematic drawing of a horizontally layered network comprising a service network;

FIG. 3 is a schematic drawing of the common user/subscriber database utilized in the present invention;

FIG. 4 is a schematic drawing of the single access point of the present invention;

FIG. 5 illustrates the relations between basics entities of the present invention;

FIG. 6 is a schematic drawing of the user data model according to the present invention;

FIG. 7 is an example using the user data model according to the present invention;

FIG. 8 is a schematic drawing of the user data record according to the present invention; and

FIG. 9 is a schematic drawing illustrating the method according to the present invention.

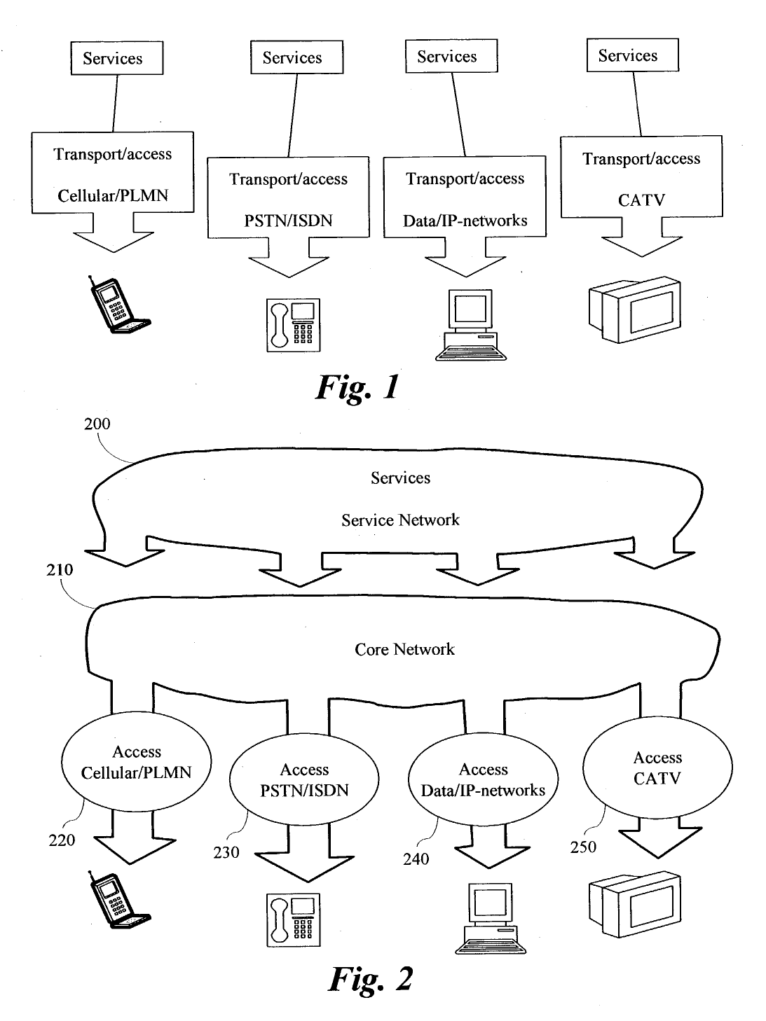

### DETAILED DESCRIPTION OF THE INVENTION

Embodiments of the invention will now be described with reference to the figures.

The present invention addresses the problems arising from the spreading of end-user related data throughout the networks by providing a Single Access Point (SAP) for end-user related data in a service network. On the highest level SAP comprises a Common Subscriber-user Database (CSD) and records of data, stored within the CSD. The records of data stores user related data and provide links to other records storing user related data. Dependencies between different service systems that interact to form a complex service are preferably also stored in the CSD. The CSD is accessible from the service network 200 and typically resides in the service network 200.

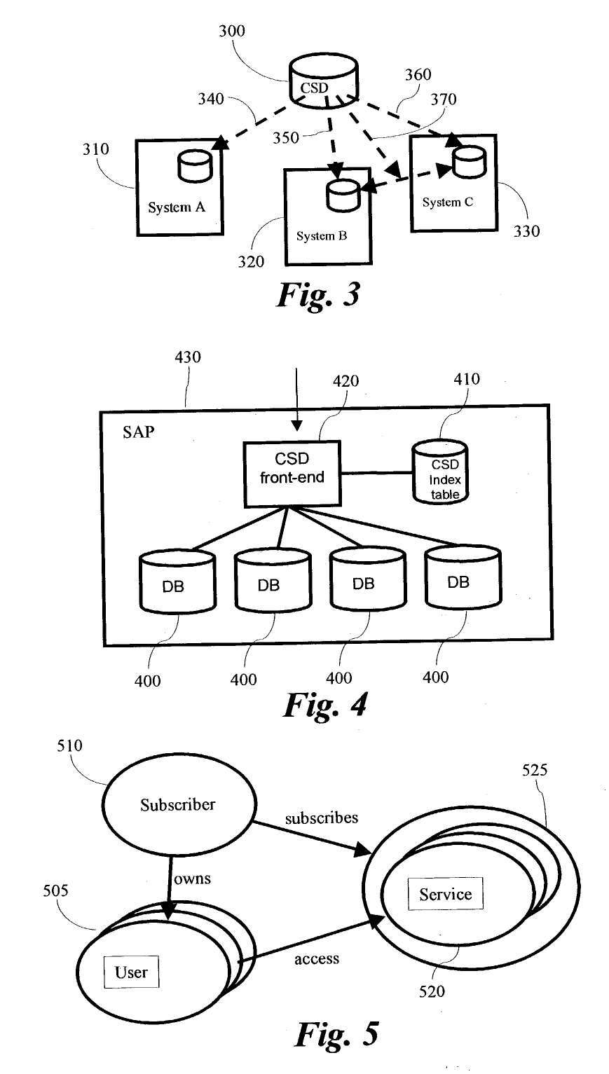

In FIG. 3 a role of the CSD is illustrated. User or subscriber related data that typically is accessed by a plurality of service systems are stored in the CSD 300. Also stored in the CSD 300 are links which links the end-user data stored within the CSD 300 to end-user related data not stored within the CSD 300. That data, referred to as affiliated data, is typically specific for a service, or group of services, and only relevant for a specific service system. Service system A 310, service system B 320 and service system C 330 are examples of systems in the service network 200 that provide a service or a group of services. Link A 340, Link B 350 and Link C 360 illustrate that the data records within CSD 300, provides links or references to the affiliate data. Common user and subscriber data is not duplicated in service systems A 310, B 320 or C 330, but stored in the CSD 300. Hence, data consistency is secured.

In the case of a complex service, which requires use of more than one service system e.g. service systems B 320 and C 330, the dependencies between the two systems B and C are stored in the CSD 300 which is illustrated by the link B+C 370. In an implementation the service system A could for example provide directory services, service system B positioning of mobile terminals and service system C could be an Internet application for finding hotels, taxis and restaurants in a city. Service system B and service system C would then have to interact to provide position based service for the end-user.

In an implemented service network the number of service system will typically be much larger than the here illustrated and the dependencies and interactions between systems may involve more than two systems. Hence, the above should be regarded as a non limiting example. Regardless of the number of systems for providing services and complex dependencies between these system common user related data is not duplicated. Hence data consistency can be secured. The structure of the data records, stored within the CSD and enabling data consistency, will be descried in detail below.

The CSD will in most realizations be a very large database as it will have to contain user related data for end-user using a plurality of services offered by the service network. This could be handled by utilizing a distributed database as illustrated in FIG. 4. The data of the CSD 300 is split to several databases 400 contained in different units. A CSD index table 410 conceals the internal distribution of the data in the databases 400. The CSD index table 410 may be stored in one of the units comprising one of the databases or in a separate unit. The databases 400 and the CSD index table 410 are connected to a CSD front-end 420 which are, in combination with the data record stored within the databases 400, a realisation of the SAP 430. The CSD front-end 420 receives all requests of data, illustrated with the arrow in the figure, and retrieve the data from the databases 400 by the use of the CSD index table 410. From the outside the CSD 300 will be perceived as one database with one access point, but on the inside a large number of separate databases 400 may be used. The detailed construction of distributed databases are known in the art and therefore omitted from the present description. It should be understood that the entities here described are to be considered as logical entities. As mentioned may the databases be distributed and provided in physically different units, but also the other entities as the CDS front end 420 and the CSD index 410 table may be realized in many different ways including being distributed over physically separated units. The Term single access point SAP should be understood in a conceptual way meaning a logical access point for end-user related data in the service network. In an realization the CDS front end 420 need to be capable of handling a large number of simultaneous accesses, as well as access by different means and methods including for example access by the use of an IP-address, an HTML-address, a E. 136-address or by an URL.

The user related data, stored in the CSD 300, are built around three basic entities. The three entities, the subscriber, the user and the service, and their relations are illustrated in FIG. 5. The entity subscriber 510 subscribes to one or more sets or packages of services 525 provided in the service network. The subscriber 510 owns one or more users 505. The user 505 are the one actively taking advantage of a service 520. The user can only use services belonging to the set of service 525 the subscriber 510 subscribes to. The user 505 will always have to belong to a subscriber 510. The subscriber 510 will always own one or more users 505. In many cases the subscriber 510 and the user 505 will be the same person, but for e.g. a business subscriber the subscriber may be the company and the users will be the employees of the company.

On a conceptual level the data identifying users, subscribers and services and definitions of the relations between these entities, are structured according to a data model referred to as the user data model. The User Data Model, UDM, comprises actual user-related data and service-related data as well as the end-user subscriptions to services. It is also the model acting as the key element in the service network responsible to make the user context in the services retrievable and manageable by keeping references to the repositories for affiliate data. In the present invention the end-user related data which are stored in the CSD 300 are structured according to the principles of the user data model. The resulting data records are referred to as User Data Records UDR, which are stored in the CSD 300. The references to affiliate data repositories corresponds to the links 340, 350, 360 from the records in the CSD 300 to the parts of the user related data which is stored in the systems A, B and C for providing services 310,320,330. The UDR may also comprise links to other type of data, for example information on available services and their characteristics.

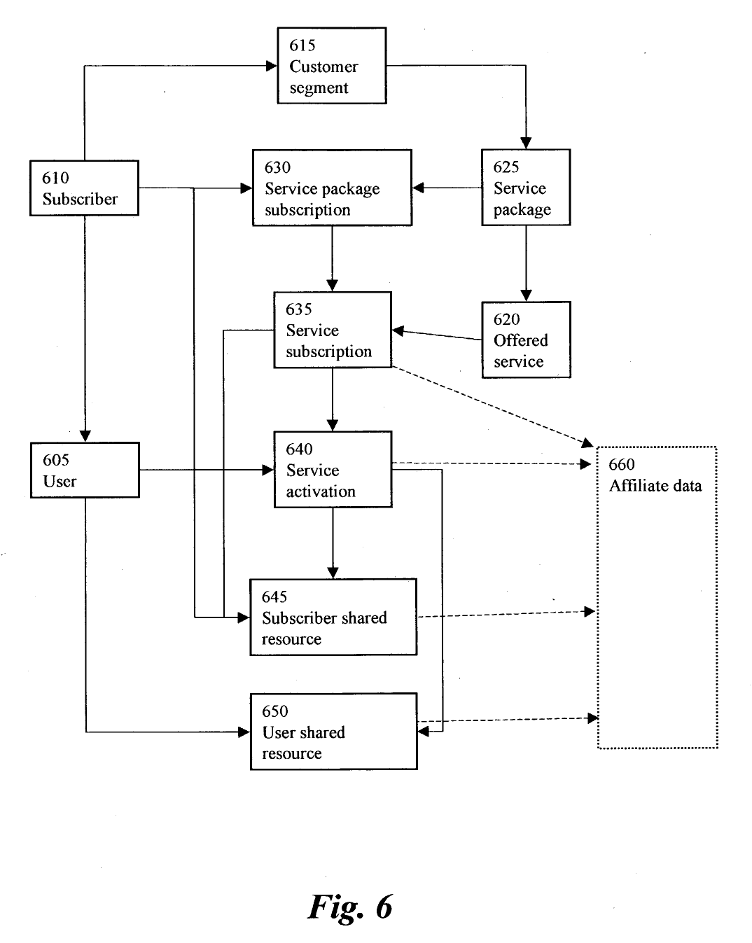

The principle of the user data model will be described with references to FIG. 6. The user data record, UDR will be constructed after the principles of the UDM. The structure of the data stored in the CSD 300 has to be carefully designed, to avoid internal replication of data, provide the correct links to the systems for providing services and maintaining the needed data in the most logical way. The data is logically grouped into objects, with key objects being subscriber, user and service, in correspondence to the main entities described above. The arrows in the figure indicates links between the objects. The implementation may vary depending on the technology used to build the CSD, but the logical grouping should be the same.

The following objects should preferably be comprised in the UDM:

User 605: contains basic User information (e.g. user identities). A user 605 is always belonging to a subscriber 610;

Subscriber 610: contains basic Subscriber information (e.g. subscriber identities);

Customer Segment 615: used to classify subscribers 610. Contains customer segment description and basic data;

Offered Service 620: contains service basic information;

Service Package 625: used to package offered services 620;

Service Package Subscription 630: used to reflect an effective subscription to a service package 625 by a subscriber 610;

Service Subscription 635: used to reflect effective subscriptions to individual services 620 in a service package by a subscriber, specified by the service package subscription 630;

Service Activation 640: used to reflect effective activation to an individual service from the service subscription 635 by a user 605;

Subscriber Shared Resource 645: contains basic data of the shared resource being used in a certain service subscribed by a subscriber 610 and specified by the service subscription 635. A shared resource is any system for providing a service needed to support service execution by another service system;

User Shared Resource 650: contains basic data of the shared resource being used in a certain service activated 640 by an user 605. This shared resource is any system needed to support service execution by another service system.

The user object 605 and the subscriber object 610 are examples of identification objects. The service subscription object 635 and the service activation objects 640 are examples of service objects. All services present in the service network 200 is known by the UDM. The subscriber 610 may then subscribe to a service. The object offered service 620 contains information on all the offered services and may hold references to service related data stored in other systems. Preferably the detailed information on a plurality of services are stored in a common service database. The common service database more detailed information about the services and the content of the offered service object 620 represents a specialization of the service information adapted for a user. The offered service 620 can thus be seen as the point of contact between the CSD 300 and the common service database. A subscriber 610 could subscribe to services one by one, but this would make the provisioning cumbersome. Preferably similar services, or service likely to attract the same subscriber, are grouped together which is reflected in the object service package 625. A certain service may be offered in a plurality of service packages. Additionally, a service package may be offered to a group of subscribers with the same characteristics and expected needs. Hence, subscribers 610 may be grouped into customer segment 615, and the subscriber 610 may subscribe to all services offered to the customer segment it belongs to. A service is added to a customer segment by including it in one or more service packages 625. In short, service packages 625 groups offered services 620 and customer segment 615 groups subscribers 610.

The subscriber 610 subscribes to services offered to its customer segment in the form of service packages 625, not in the form of individual services. If a service is needed to be offered separately, it has to be included in a service package 625. The object service package subscription 630 holds the information of the service packages to which the subscriber subscribes, and the object service subscription 635 holds information on the included individual offered services 620. These are the service offered to the individual user 605. The user may chose to use all the services that the subscriber subscribes to, but most probably the user will make a selection of services. The users choice of services is contained in the object service activation 640. The object service activation 640 contains references to the affiliate data.

Complex service often require involvement of two or more systems for providing services, as for example in the previously described example of booking a hotel. A positioning based service would typically involve the systems mobile positioning centre, MPC and the home subscriber server, HSS, where the user's profile for the mobile network (access network) is stored. The systems like MPC and HSS are example of shared resources, or service enablers. The objects subscriber shared resources 645 and user shared resources 650 contains the dependencies between different systems to provide a complex service and the references to the affiliate data of these systems. The specified dependencies prevent that data necessary for one service system is changed or removed by another, for example that one service system which uses the MPC terminates the subscription/activation of the MPC if another service system needs the subscription/activation to perform its complex service.

Another example of a shared resource utilized by a plurality of complex services is a calendar. A user typically wants only one calendar showing all entries regardless of how the different entries have been created. In the above example of booking a hotel, the service booking a hotel preferably also access the calendar to automatically enter the reservation. The user uses the same calendar to book meetings, remember birthdays etc. In a business scenario a subscriber may want all its users to have access to a common calendar, or each others calendars, to be able to use functions that for example automatically checks when a group of users are free to have a meeting. Hence, the service “calendar” can depending on the use, be regarded as a stand-alone service, or a “building block”, or service enabler, for complex services.

In alternative embodiment of the present invention the dependencies between service to form a complex service or the use of a shared resource are not stored within CSD, but in the common service database. In this embodiment the dependencies between service are stored at a per service level in the common service database, not at a user/subscriber level in the CSD. By this alternative arrangement fewer dependencies have to be stored in the service system since the dependencies will be common to a large number of users and the number of user typically vastly outnumbers the number of services. On the other hand must the common service database be addressed to gain knowledge of the dependencies between service, for example if a user deactivates a complex service. In order to maintain the concept of having only one access point for all user/subscriber related data, the access to the common service database is preferably arranged, in the cases of checking dependencies between service for the purpose of updating user/subscriber data, to be made thorough the SAP. [correct?]

The service network may provide services to a plurality of different access network using different communication technologies, for example circuit switched mobile systems like GSM, packet switched systems like GPRS or combined systems like UMTS. The UDM provides for storing information on which access networks an end-user may utilize as well as user IDs and attributes for the access networks.

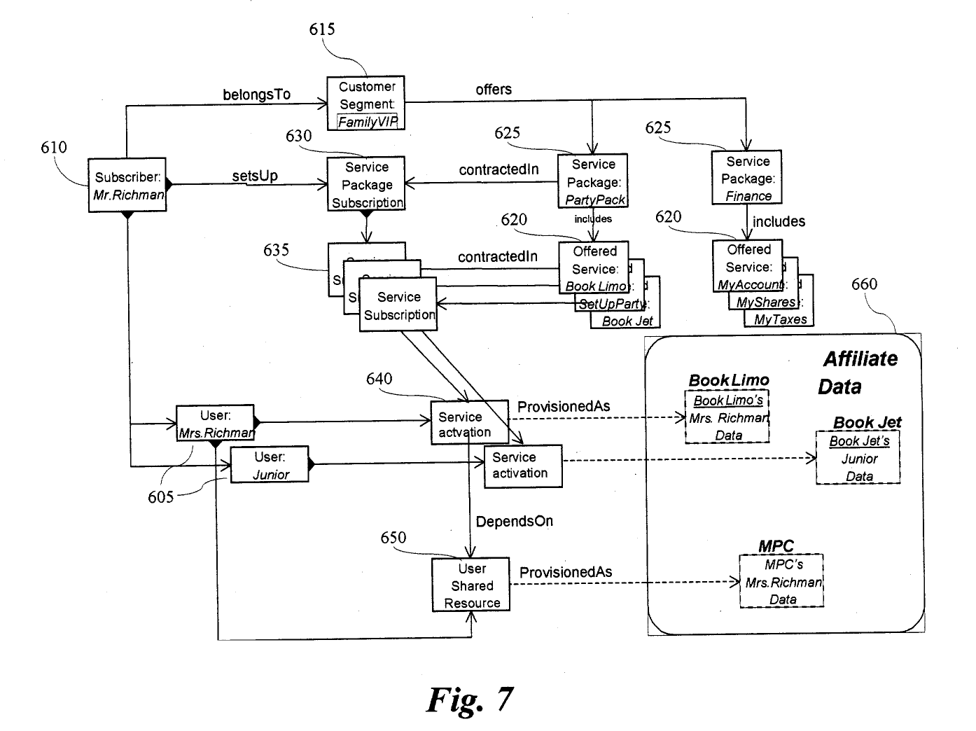

An example illustrating the principles of the UDM will be described with references to FIG. 7. The schematic view illustrates a subscriber and two users taking advantage of a few services offered in the service network. This is to keep the example clear and imposes no limitations to the invention. In reality a subscriber/user typically uses a larger number of services.

The Richman family are service network customers that registered to the Customer Segment 615: FamilyVIPS. The Richman family is made up of Mr. Richman, Mrs. Richman and Junior and the only one entitled to actually subscribe services is the father, Subscriber 615: Mr. Richman. Their Customer Segment offers them Service Package 625: Party Pack and the Service Package:Finance.

The “box” Affiliate Data 660 represents all Affiliate Data taking part in the services. In this case, the Affiliate Data 660 for Offered Services 620 Book Limo and Book Jet services, as well as the Affiliate Data for the Shared Resource 650 MPC. It should be noted note that, in this example, the Offered Service 620: Book Limo is a Location-Based Service therefore dependent on the User Shared Resource 650 MPC.

The Service Package 625: PartyPack is the one they really need. So they have bought it as it is reflected with the existence of the corresponding Service Package object related to the Subscriber 610: Mr. Richman and the Service Package 625: PartyPack. Buying this Service Package result in the creation of three Service Subscriptions 635, one per Offered Service 620 included in the Service Package 625: Party Pack.

On the other hand the Service Package 625: Finance is not that attractive for this family yet as can be derived from the fact that no Service Package Subscription 630 for that purpose can be seen in the picture.

One User 605: Mrs. Richman—is entitled to use the Offered Service 620: Book Limo. This is represented by the existence of a Service activation object 640 related to the Service Subscription 635, in turn, related to the Offered Service 620: Book Limo. There also exists the corresponding User Data object in the Book Limo Affiliate for User: Mrs. Richman. Note that this is the only Offered Service that she can use so far, so when she will become interested in using another service then a new Service activation object 640 has to be created accordingly. Subscriber 610: Mr. Richman has to give his consent to this since he pays the bills.

The other User 605 —Junior— fond of flying is entitled to use the Offered Service 620: Book Jet, also included in the subscribed Service Package 625: Party Pack. There also exists the corresponding User Data object in the Book Jet Affiliate Data for User: Junior. Please note that this is the only Offered Service that he can use so far, so when he will become interested in using another service then a new Service activation object 640 has to be created accordingly. Again Subscriber: Mr. Richman has to give his consent to this since he pays the bills after all.

The third Offered Service 620: Set up Party in the Service Package 625: PartyPack has not been subscribed for any of the Users, so neither Subscription activation object nor User Data exist in the Affiliate data for this Service and these Users.

Since the Offered Service 620: Book Limo is a location-based service User: Mrs. Richman has also been provisioned to the MPC as reflected in the existence of the corresponding User Shared Resource 650 and the User Data object in the MPC Affiliate Data.

On the contrary the Offered Service Book Jet does not need any User Data to be provisioned in a Shared Resource, so no User Shared Resource object has been created for User: Junior related to this service.

In this example there are neither Subscriber Data objects in the Affiliate Data nor Subscriber Shared Resources objects, because none of the subscribed services in the example require a common environment for its different users (therefore there is in this example no need to provision Subscriber Data to any Affiliate Data, although the invention allows that type of provisioning). In this example the Service Subscription objects role is to simply link the Subscriptions to the Offered Services they are related to.

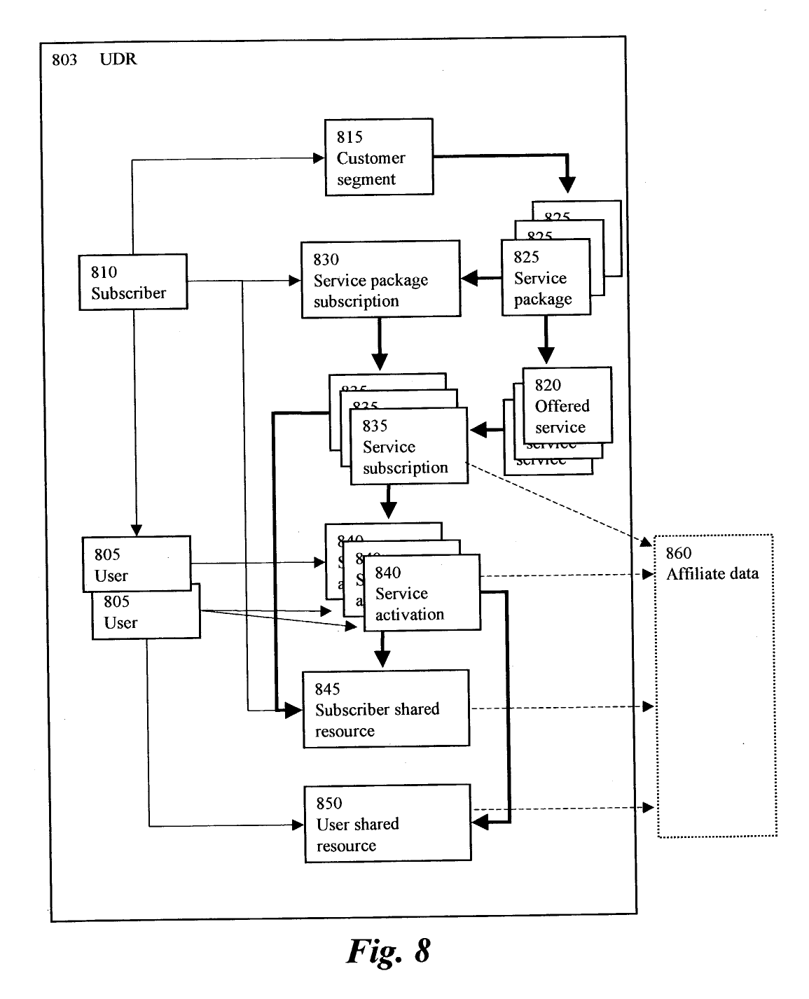

The user, subscriber and service data stored in the CSD 300 are structured according to the above described UDM. A resulting data record will be described with references to FIG. 8. In the figure arrows indicate dependencies between fields, the thinner arrows a one-to-one dependence and the thicker arrows indicating dependence between a plurality of fields. The user data record, UDR 803, will comprise a subscriber field 810 containing basic subscriber information e.g. subscriber identities. One or more user fields 805 specifies the users owned by the subscriber. The user field 805 and the subscriber field 810 are examples of identification fields. A customer segment field 815 characterize the subscriber and defines which service packages the subscriber will be offered. Service package fields 825, one for each package, defines the available service packages and linked to each service package field 825 are offered service fields 820 which contains basic service information for each separate service. The service package subscription field 830 defines which services package the subscriber subscribes to and the service subscription fields 835, one for each service, defines all the individually available services. As previously described each user may chose which services to activate (from the services of the service activation fields 835), and each users selection of services is specified in the service activation field 840. Hence, each user field 805 is linked to service activation fields 840. The service activation fields 840 contains the links to affiliate data, i.e. the part of the end-user data stored in the service system 340, 350, 360. A link may preferably be an address, e.g. an IP address, to the affiliate data repository. The service subscription field 835 and the service activation field 840 are examples of service fields. If any of the services selected by the users require the use of shared resources, i.e. more than one complex service uses the same service system, the dependencies between the systems as well as the links to the affiliate data stored in these system, will be contained in a user shared resource field 850. In the same manner a subscriber shared resource field 845 contains the dependencies between systems on the subscriber level.

The UDR may not only comprise the links to affiliate data but also information necessary to access the affiliate data or to use a shared resource, for example. An example of such information is the different means for identifying a user that are used in different services. Traditional telephony services typically uses the phone number as the identifier, an email service uses an email address and a calendar function uses an alias. A complex service may, then using different service systems, need one or more of these different means of identifying a user. The different means of identifying a user need to be linked together, so called identity mapping. This is provided by the data model and data record according to the invention by, in the UDR, include the different means of identification and to which service they belong, preferably in the fields also holding the links to the service system i.e. the subscriber shared resource field 845, the user shared resource field 850 and the service activation fields 840.

The described data record and the contained field could be realized in a number of ways, primarily depending on the technology used in the database. Such implementation details are considered to be obvious for the skilled in the art. Also other fields than the above mentioned examples may provide links to affiliate data. However, in order to keep the implementation simple and promote data consistency, the number of different fields providing such links should preferably be limited and care should be taken to not provide unnecessary and/or duplicating links.

The links contained in the service activation fields 840, the subscriber shared resource field 845 and the user shared resource field 850 are the only connection points between the main user data stored in the CSD 300 and the affiliate data of the service systems 340, 350, 360. This is important for maintaining the consistency of the user data. The affiliate data should only be used within its service system. Request for user and subscriber data should be made to the single access point, preferably realized by the CSD front-end 420 and the UDR 803 from which the CSD front-end 420 retrieves the subscriber and user data.

In accordance with the previously described alternative embodiment of the present invention the user shared resource field 850 and the subscriber shared resource field 845 are not needed if the dependencies between the service are stored in the common service database. Corresponding fields are instead provided within the data records of the common service database.

The SAP may be accessed for performing data management, such as updating end-user data, and for real-time uses, such as retrieving data necessary to perform a service. The data management comprises user management, subscriber management, service management, customer segment management, service subscription and activation and service package management. Real-time uses occur during execution of an application in a service system. The application, for example, provides a location based service. The application needs to provide certain user data to the location based service, data which is retrieved from the SAP. Another example is then an application needs references to affiliate data and knowledge of some of the different user IDs, names and alias associated with a user.

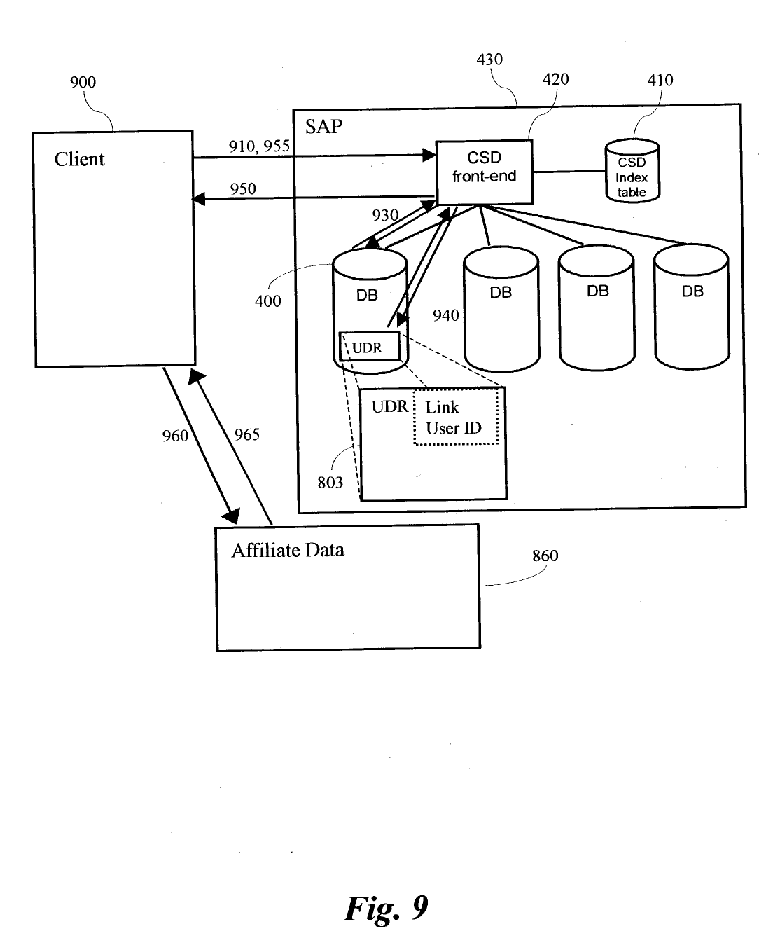

The method of accessing user and subscriber data according to the present invention, utilizing the SAP of the present invention, will be described with references to the schematic illustration of FIG. 9. The accessing functionality is here represented by a client 900 which may perform the data managing functions or the real-time uses described above. Detailed examples are presented in the subsection “use cases” below. The use of the client is typically initialized by an application in a service system for performing a service or by an data management application initialized by a service provider or another player in the service network. Hence, a certain client is often, but not necessarily, linked to a certain service system. The method comprises the steps of:

910: The client accesses the SAP via the CSD front-end 420. The access may preferably include a request/grant procedure to establish the rights of the accessing data management function, for example read and/or write permission.

920: The client request to read and/or write data from CSD front-end 420 typically by referring to a user or subscriber ID.

930: By the use of the CSD index table 410, the CSD front end 420 access the correct database in the distributed database; and

940: the CSD front end 420 retrieves or transfers data from or to the UDR 803.

950: The CSD front end 420 returns the requested data to the client.

The method may optionally comprise the steps of:

955: If the client require access to user data not stored within the SAP, i.e. the affiliate data, the SAP is first accessed according to the above steps. From e.g. the service activation field 840 the client is provided with a link to the affiliate data and information such as user ID or user name needed to access the affiliate data.

960: The client access the affiliate data repository using the information from the SAP, and request user related data.

965: The affiliate data repository returns the user related data to the client.

The method may further optionally comprise the step of:

970: If the client intends to change, remove or add user data the UDR 803 should be checked for dependencies between different service systems i.e., in the described exemplary implementation, check user shared resource field 850 and the subscriber shared resource field 845 for dependencies between different service systems. The client will if such dependencies exist be informed that user data may be used by other service systems and should normally not be changed or removed.

Depending on the type of managing action, the details of each step will vary. The key feature being that alteration of user and subscriber data is directed to the SAP. To change the affiliated data, which typically is stored in the service systems, the SAP is accessed to get information on where to find appropriate affiliate data repositories i.e. information given in the service activation field 840, user shared resource field 850 and the subscriber shared resource field 845. The affiliate data is then access directly at its repository. Alternatively may, if such functionality is provided to the SAP, the affiliate data be accessed through the SAP.

The access of step 910 may be performed in a number of different ways including by the use of an IP-address or an ULR, and the SAP is via the CSD front end 420 capable of handling a variety of different access methods and different means of access, as well as a plurality of simultaneous accesses. Different access methods are known in the art.

The above described method according to the invention may be realised as a computer program product or part of computer program product. The program product is for example executed on a computer belonging to a service system in the service network 200.

The SAP and the method according to the invention has here been described as extending over all services in a service network. This is a preferred implementation. However, the SAP may coexist with service systems not utilizing the invention in a service network, but only the service systems using the SAP will take advantage of the advantages afforded by the invention.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

### EXAMPLES OF USE CASES

In the example the term Administrator refers to a managing functionality in the service network and typically acting through a software client, in a client-server scenario.

Data Management

User Management

Get User

Expected result:

Information related to a User in the SN User Data Model is retrieved.

Preconditions:

At least one User must exist.

Description of the case:

An Administrator needs to retrieve User information and requests it to the SAP. The information requested (User information and/or Subscription data and/or Network Access data and/or User Shared Resources) is retrievable, provided that the Administrator has the proper permission to read it.

With this information provided by the SN User Data Model, the system used by the Administrator (for example a provisioning tool) may need to retrieve user info outside the SN User Data Model, that is, reach some Affiliate Data repositories where the actual Subscription data and/or User Shared Resources data reside. For this purpose, the retrieved references (providing user ids and service addresses) the SN SAP keeps towards these Affiliate Datas shall be followed and the appropriate data access protocol published by that Affiliate shall be used.

Create user

Expected result:

A new user is defined.

Preconditions:

At least one Subscriber must exist. In case of private users, the Subscriber is created in the same process as the User.

Description of the case:

An administrator wants to create a new User. For this purpose, the Administrator enters the basic data for the user and chooses a Subscriber that the User will be associated to. A new User record is then created in the SAP, and associated to a Subscriber. This association is inherent to the process since a user can not exist isolated, since it has to make use of just the subscriptions created by its Subscriber.

Remove user

Expected result:

A specific User, and all its related information, is removed from the SAP.

Preconditions.

At least one User must exist.

Description of the case:

An Administrator wants to erase a User from the SAP. The system used by the Administrator (typically a provisioning system) will get first the Service references and User Shared resources references to the Affiliate Data repositories where service data reside, in order to go to each repository and remove the User service data it is stored in each one. Then, the User object, plus the Subscription objects and/or Network Access objects and/or User Shared Resources objects will be erased.

Update User

Expected result:

An Administrator modifies User data.

Preconditions:

At least one User must exist.

Description of the case:

An Administrator (could be the user itself) wants to change User basic data (the only affected object is User object). The User object information is updated in the SAP.

Subscriber Management

Get Subscriber

Expected result:

Information related to a Subscriber in the SN User data model is retrieved.

Preconditions:

At least one Subscriber has been defined.

Description of the case:

An Administrator requests a Subscriber's related info to the SAP. This information may consist of any of the following: Subscriber basic data, Service Package Subscription, Service Subscription data, Customer Segment data, Subscriber Shared Resources data, and list of Users.

With this information provided by the SN User Data Model the system used by the Administrator (for example a provisioning tool) may need to retrieve Subscriber info outside the SAP, that is, reach some Affiliate Data repositories where the actual Service Subscription data and/or Subscriber Shared Resources data reside. For this purpose, the retrieved references (providing user ids and service addresses) the SAP keeps towards these Affiliate Datas shall be followed and the appropriate data access protocol published by that Affiliate shall be used.

Service Management

Get service

Expected result:

An Offered Service is fetched from SAP.

Preconditions:

At least one Service has been defined.

Description of the case:

An Administrator requests Offered Service info to the SN SAP. The data contained in the Service object is retrieved.

Add a service

Expected result:

A new Offered Service is ready to be packaged.

Preconditions:

A service has been developed, deployed and configured, that is, there exists a Provided Service, whose information is available from other parts of the SN.

Description of the case:

In order to make a Provided Service available for subscription, the first step is to make the SAP aware of it by creating an Offered Service object.

At Offered Service creation the Offered Service template must be provided by the administrator.

Customer Segment

Get Customer Segment

Expected result:

A Customer Segment and associated information is retrieved from SAP.

Preconditions:

At least one Customer Segment must exist.

Description of the case:

An Administrator, typically through a provisioning system, may need to know the information associated to a Customer Segment. Such info is requested to the SN SAP, which sends the Customer Segment information plus the Service Packages information associated to it (it includes the Services contained in each Service Package).

Variations:

Additionally, the list of Subscribers belonging to that Customer Segment can be retrieved.

Create Customer Segment

Expected result.

A new Customer Segment is defined, and subscribers can be associated to it.

Preconditions.

At least one Service Package must exist.

Description of the case:

Customer segmentation allows subscriber categorisation and service grouping. Every subscriber must belong to a (one) Customer Segment, so these ones must be created before Subscribers are defined.

For this purpose, an administrator creates a Customer Segment associating some of the available Service Packages to it. The Services contained in those Service Packages constitute the service offering for every subscriber associated to this new Customer Segment. A new Customer Segment object is added in the SAP, linked to the selected Services.

Service Subscription & Activation

Create a Subscription

Expected result:

It becomes possible to activate a particular Offered Service for a particular User. See next 0.

Preconditions:

The actor (Subscriber) has already subscribed the Service Package.

Description of the case:

The Subscriber wants to make it possible that a Service can be activated and used by the users. A Subscription object has to be created and associated to the Offered Service via the pre-existing user independent Service Subscription.

User provisioning has to be performed according to the Affiliate provisioning Contract and by provisioning the fixed subscription-related information to the Affiliate as set up in the Offered Service Template. This result in the creation of a new User Data object in the Affiliate Data.

The Subscription object will point at this user context in the Affiliate so that further activation, and other provisioning related activities are supported. This reference will consist of the user id assigned by the application and the address of the Affiliate.

Activate service

Expected result:

A Service is ready to be used for the first time.

Preconditions:

A Subscription related to this User and this Offered Service has been created according to the above.

Description of the case:

The last step to have a certain Offered Service ready for use is its activation. An Administrator (in some cases maybe simply the User) provides personal information that is required for the service activation according to its Provisioning Template. The activation settings are forwarded to the Affiliate Data repositories according to their Affiliate Provisioning Contract.

The corresponding object in the SAP (the Subscription object) is updated to reflect that the Service has been activated.

References (the service user id plus the affiliate address) towards the Affiliate Data repository where the service resides, and the relation between the Service and the Shared resources it needs must also be established.

Real-time Use Cases

Get shared resources

Expected result:

An Application gets the shared resources being used by a User or a Subscriber. The Application may use this information to access the resource for service execution purposes.

Preconditions:

At least one service for the User must be ready to use.

Description of the case:

The services offered by applications may need to access, at execution time, to the shared resources that support the service execution process. For example, an application offering a location-based service, will need to access an enabler which gets the location info from the access network and makes it visible to applications.

For this purpose, the applications willing to get info about shared resources belonging to an user/subscriber, will request it using the identity of the User. Since all possible identities are kept in the SN User data model, and there is also an association of each service with its shared resources, the requested information is delivered to the application.

Get User Ids

Expected result:

An Application gets any of the User Ids. The Application may use this information for service execution purposes.

Preconditions:

At least one User must exist.

Description of the case:

A service offered by an Application can use any identification for an User but, due to service characteristics, it may be needed to know other identities of the User (for example having the e-mail address, could be interesting to know the MSISDN to send an e-mail in SMS format). The SN SAP has knowledge of all user identities, so the information requested is sent.

Get Service list

Expected result:

The list of subscribed services is sent to an entity accessing SN SAP.

Preconditions:

At least one User exists.

Description of the case:

For authorisation purposes, there are some entities which may be interested in getting the list of subscribed services to an User, so that when an attempt to use that service is done, it is checked whether this User has rights to use that Service. For that purpose, the SAP is able to construct and send this list when requested.

1. A system for storing and maintaining user and subscriber data in a service network with a plurality of service systems for providing a plurality of services, the system comprising a subscriber/user database, which comprises subscriber/user data records with user and subscriber information, wherein the subscriber/user database is a common subscriber/user database holding subscriber/user information relevant for a plurality of services, and wherein the subscriber/user data records comprise:
at least one identification field identifying a subscriber and a user; and
at least one service field specifying at least one selected service from said plurality of services provided in the service network, wherein the at least one selected service is selected by the user or subscriber,
wherein at least on of said at least one service field is adapted for providing links to affiliate data relating to the subscriber/user and which affiliate data is stored outside of said common subscriber/user database,
whereby the common subscriber/user database and the subscriber/user records facilitate a single access point for accessing user and/or subscriber data in the service network.

2. System according to claim 1, wherein the subscriber/user data records comprise at least the two service fields:
a service subscription field specifying a first group of services available to the subscriber, wherein the services in the first group of services is selected from said plurality of services provided in the service network; and
at least one service activation field, each service activation field specifying a by the user activated service selected from the first group of services,
wherein said service subscription field and/or service activation fields are adapted for providing links to affiliate data relating to the subscriber/user and which affiliate data is stored outside of said common subscriber/user database.

3. System according to claim 2, wherein the user data records comprise:
a plurality of user fields, each user field identifying a user and each user belonging to the subscriber; and
at least one service activation field for each user, which service activation fields are linked to respective user field, the service activation fields specifying a per user group of services available to respective user, the per user groups of services being selections of services from the first group of services, and wherein said service activation fields provides links to affiliate data stored outside of said common subscriber/user database.

4. System according to claim 3, wherein the common subscriber database is a distributed database.

5. System according to claim 3, wherein the user data records stores dependencies between different service systems for performing a complex service.

6. System according to claim 3, wherein the links to affiliate data is in the form of an IP-address, a URL, an HTML-address or an E. 163 address.

7. System according to claim 3, wherein the links to affiliate data is in the form of an address recognizable in an IP based network.

8. System according to claim 5, wherein the user data records for each user comprise a user shared resource field which is linked to the user field and the service activation field and said user shared resource field stores dependencies between service systems, which dependencies are on a user level.

9. System according to claim 5, wherein the user data records comprise a subscriber shared resource field which is linked to the subscriber field and the service subscription field said subscriber shared resource field stores dependencies between service systems, which dependencies are on a subscriber level.

10. System according to claim 3, wherein the user data records for each user stores a plurality of means for identification of the respective user.

11. System according to claim 10, wherein the means for identification is one or more of the following: a phone number, a personal identification code, an email address, a name or an alias.

12. System according to claim 10, wherein the means for identification is stored in fields also storing dependencies between service systems.

13. System according to claim 2, wherein different service systems in combination forms a complex service or one service system serving as a shared resource for a plurality of other services, the dependencies between the different service systems are stored in a common service database.

14. System according to claim 3, wherein the user data records further comprise a plurality of fields specifying services available to the users, the plurality of fields comprises:
at least one service package field, each service package specifying a group of services available to the subscriber specified in the subscriber field;
a customer segment field 815 adapted for characterizing the subscriber of the subscriber field and specifying service packages; and
at least one offered service field 820 comprising service information for each separate service included in the service package specified by the service package fields.

15. A data record adapted for storing and maintaining user and subscriber data in a service network with a plurality of service systems for providing a plurality of services, the system comprising a subscriber/user database, which comprises subscriber/user data records with user and subscriber information, wherein the subscriber/user database is a common subscriber/user database holding subscriber/user information relevant for a plurality of services, and wherein the subscriber/user data records comprise:
at least one identification field identifying a subscriber and a user; and
at least one service field specifying at least one selected service from said plurality of services provided in the service network, wherein the at least one selected service is selected by the user or subscriber,
wherein at least on of said at least one service field is adapted for providing links to affiliate data relating to the subscriber/user and which affiliate data is stored outside of said common subscriber/user database,
whereby the common subscriber/user database and the subscriber/user records facilitate a single access point for accessing user and/or subscriber data in the service network.

16. Data record according to claim 15, wherein the subscriber/user data records comprise at least the two service fields:
a service subscription field specifying a first group of services available to the subscriber, wherein the services in the first group of services is selected from said plurality of services provided in the service network; and
at least one service activation field, each service activation field specifying a by the user activated service selected from the first group of services,
wherein said service subscription field and/or service activation fields are adapted for providing links to affiliate data relating to the subscriber/user and which affiliate data is stored outside of said common subscriber/user database.

17. Data record according to claim 16, wherein the user data records comprise:
a plurality of user fields, each user field identifying a user and each user belonging to the subscriber; and
at least one service activation field for each user, which service activation fields are linked to respective user field, the service activation fields specifying a per user group of services available to respective user, the per user groups of services being selections of services from the first group of services, and wherein said service activation fields provides links to affiliate data stored outside of said common subscriber/user database.

18. Data record according to claim 16, wherein the user data records stores dependencies between different service systems for performing a complex service.

19. Data record according to claim 18, wherein the user data records for each user comprise a user shared resource field which is linked to the user field and the service activation field and said user shared resource field stores dependencies between service systems, which dependencies are on a user level.

20. Data record according to claim 18, wherein the user data records comprise a subscriber shared resource field which is linked to the subscriber field and the service subscription field said subscriber shared resource field stores dependencies between service systems, which dependencies are on a subscriber level.

21. Data record according to claim 17, wherein the user data records for each user stores a plurality of means for identification of the respective user.

22. Data record according to claim 21, wherein the means for identification is one or more of the following: a phone number, a personal identification code, an email address, a name or an alias.

23. Data record according to claim 21, wherein the means for identification is stored in fields also storing dependencies between service systems.

24. Data record according to claim 17, wherein the user data records further comprise a plurality of fields specifying services available to the users, the plurality of fields comprises:
at least one service package field, each service package specifying a group of services available to the subscriber specified in the subscriber field;
a customer segment field adapted for characterizing the subscriber of the subscriber field and specifying service packages; and
at least one offered service field comprising service information for each separate service included in the service package specified by the service package fields.

25. A user data model adapted for storing and maintaining user and subscriber data in a service network with a plurality of service systems for providing a plurality of services, the system comprising a subscriber/user database, which comprises subscriber/user data records with user and subscriber information, wherein the user data model is adapted for facilitating storage of user and subscriber data in a common subscriber/user database, and the common subscriber/user database holds subscriber/user information relevant for a plurality of services, and the user data model comprises:
at least one identification object identifying a subscriber and a user; and
at least one service object specifying at least one selected service from said plurality of services provided in the service network, wherein the at least one selected service is selected by the user or subscriber,
wherein at least on of said at least one service object provides links to affiliate data relating to the subscriber/user and which affiliate data is stored outside of said common subscriber/user database,
whereby the common subscriber/user database and the data model facilitate a single access point for accessing user and/or subscriber data in the service network.

26. Data model according to claim 25, wherein the subscriber/user data records comprise at least the two service objects:
a service subscription object specifying a first group of services available to the subscriber, wherein the services in the first group of services is selected from said plurality of services provided in the service network; and
at least one service activation object, each service activation object specifying a by the user activated service selected from the first group of services, wherein said service subscription object and/or service activation objects are adapted for providing links to affiliate data relating to the subscriber/user and which affiliate data is stored outside of said common subscriber/user database.

27. Data model according to claim 26, wherein the user data model comprise:
a plurality of user objects, each user object identifying a user and each user belonging to the subscriber; and
at least one service activation object for each user, which service activation object is linked to respective user object, each service activation object specifying a per user group of services available to respective user, the per user groups of services being selections of services from the first group of services, and wherein said service activation objects provides links to affiliate data stored outside of said common subscriber/user database.

28. Data model according to claim 27, wherein the user data model defines dependencies between different service systems for performing a complex service.

29. Data model according to claim 28, wherein the user data model for each user comprise a user shared resource object which is linked to the user object and the service activation object, and said user shared resource object defines dependencies between service systems, which dependencies are on a user level.

30. Data model according to claim 28, wherein the user data model comprise a subscriber shared resource object which is linked to the subscriber object and the service subscription object, and said subscriber shared resource object defines dependencies between service systems, which dependencies are on a subscriber level.

31. Data model according to claim 28, wherein the user data model for each user defines a plurality of means for identification of the respective user.

32. Data model according to claim 31, wherein the means for identification is one or more of the following: a phone number, a personal identification code, an email address, a name or an alias.

33. Data model according to claim 31, wherein the means for identification is defined in objects also storing dependencies between service systems.

34. Data model according to claim 27, wherein the user data model further comprise a plurality of objects specifying services available to the users, the plurality of objects comprises:
at least one service package object, each service package specifying a group of services available to the subscriber specified by the subscriber object;
a customer segment object adapted for characterizing the subscriber of the subscriber object and specifying service packages; and
at least one offered service object comprising service information for each separate service included in the service package specified by the service package objects.

35. A method of accessing user and subscriber data in a service network, wherein the service network comprises a plurality of service systems offering a plurality of services, the method comprising the steps of:
accessing a single access point in the service network;
requesting to read and/or write data from the single access point,
retrieving or transferring data from or to a subscriber/user data record via the single access point, wherein the user data record wherein the subscriber/user data records comprise: at least one identification field identifying a subscriber and a user; and at least one service field specifying at least one selected service from said plurality of services provided in the service network, wherein the at least one selected service is selected by the user or subscriber, wherein at least on of said at least one service field is adapted for providing links to affiliate data relating to the subscriber/user and which affiliate data is stored outside of said common subscriber/user databaseREFREF.

36. The method according to claim 35 further comprising the step of:
checking if the subscriber/user data record comprises information on dependencies between different service systems.

37. The method according to claim 36 wherein the step of checking comprises
checking the service activation field, user shared resource field and the subscriber shared resource field for links indicating dependencies between different service systems.

38. The method according to claim 35 further comprising the steps, to be taken if affiliate data which is not stored within the single access point is required, of
accessing the single access point for retrieving links to the affiliate data and information required to access the affiliate data;
accessing an affiliate data repository using the link and information retrieved in the previous step.

39. The method according to any of claims REF38 wherein the steps are performed by a software client.

40. A computer program product directly loadable into the internal memory of a processing means within a unit in the service network, comprising the software code means adapted for controlling the steps of claim 35REF.

41. A computer program product stored on a computer usable medium, comprising readable program adapted for causing a processing means in a processing unit for a unit in the service network to control an execution of the steps of any of the claims 35REF.
